(19) United States
(12) Patent Application Publication
(10) Pub. No.: US 2001/0026064 A1
(43) Pub. Date: Oct. 4, 2001

(54) Method for inflating a gas bag, a gas generator to carry out the method and a vehicle occupant restraint system

(75) Inventors: Maximilian Bergmann, Schwindegg (DE); Uwe Dolling, Ampfing (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Airbag Systems GmbH & Co. KG

(21) Appl. No.: 09/821,551

(22) Filed: Mar. 29, 2001

(30) Foreign Application Priority Data
Mar. 30, 2000 (DE) 100 15 837.4

(51) Int. Cl. B60R 21/26

(52) U.S. Cl. 280/737; 280/736

(57) ABSTRACT

A vehicle occupant restraint system has a gas generator and a gas bag. A method for inflating a gas bag for restraining an occupant comprises the following steps: providing a gas generator for producing gas which is flowingly connected to the gas bag, providing at least one propellant charge within the gas generator, providing at least one igniter within the gas generator, the gas generator blowing gas into the gas bag over more than one second, preferably over more than three seconds, in order to achieve a high service time.

### TECHNICAL FIELD

The invention relates to a method for inflating a gas bag, a gas generator to carry out the method and an inflatable vehicle occupant restraint system operating by means of the proposed method.

### BACKGROUND OF THE INVENTION

Vehicle occupant restraint systems comprising a gas generator and a gas bag are usually constructed such that the gas bag is inflated by the gas generator within a few milliseconds and the gas bag provides its protective effect after approximately 20 ms. This protective effect is, however, maintained only over a few milliseconds. Then the gas bag collapses. In so-called window bags, i.e. gas bags which cover the side windows of a vehicle across a large area, the so-called service time of the gas bag, i.e. the time during which it remains inflated and offers a protective effect, is extended in that the gas bag is constructed in a gas-tight manner. This gas-tightness is, however, only to be achieved with a high expenditure. A disadvantage also is that the inflated gas bag can be a hindrance when rescuing or on leaving the vehicle.

### BRIEF SUMMARY OF THE INVENTION

The invention provides a method which provides for longer service times in a more reliable manner and avoids the above disadvantages. The method for inflating a gas bag according to the invention comprises the following steps: providing a gas generator for producing gas which is flowingly connected to said gas bag, providing at least one propellant charge within the gas generator, providing at least one igniter within the gas generator, the gas generator blowing gas into the gas bag over more than one second. The method, therefore, follows a contrary direction to the prior art, by not exclusively providing the entire quantity of gas within the shortest period of time, but rather by, for the first time, permanently blowing gas into the gas bag over a very long period of time until after the first contact of the occupant with the gas bag (primary impact). The invention is not only limited to side gas bags, rather the method is also able to be used in drivers', passengers' and knee gas bags.

Preferably the gas generator will provide so much gas after its activation that within a maximum of 30 ms, preferably 20 ms after activation of the gas generator, the gas bag is fully inflated.

Through the method proposed, such great demands with respect to tightness no longer have to be made on the gas bag, in order to increase its service time. Furthermore, it is possible that the gas bag automatically collapses after a few seconds and hence it is no longer a hindrance when the occupant is being rescued or when he is climbing out of the vehicle.

To carry out the method proposed, it is theoretically possible to use gas generators which provide the entire quantity of gas rapidly and introduce it into an intermediate reservoir which directs the gas to the gas bag with the desired chronological sequence.

Preferably, however, the method is carried out by means of one gas generator which for its part produces gas over more than one second, preferably even over three or five seconds. This time is the total time within which gas is blown out from the gas generator, it of course being possible that a plurality of propellant charges is used and between the igniting of individual propellant charges a specific time elapses, within which no gas flows out from the gas generator and within which therefore also no gas is generated.

As explained, the gas generator proposed is equipped with at least one propellant charge and at least one igniter, the propellant charge having such a nature and being accommodated in the gas generator such that it generates gas over more than one second, preferably over more than three or even more than five seconds. With three seconds, sufficient restraining energy is still made available in particular for a secondary impact; with five seconds, a sufficient protective effect is still present even in the case of a roll-over of the vehicle.

The gas generator proposed preferably has several propellant charges which are able to be activated chronologically in succession and which preferably are comprised of different fuels.

According to the preferred embodiment, a propellant charge is ammonium nitrate, a particularly slow-burning fuel.

The propellant charge of ammonium nitrate forms a propellant charge which is to be ignited after a primary propellant charge.

Preferably the gas generator is constructed such that the propellant charge to be ignited subsequently burns at a maximum of 2 bar combustion pressure, in order to thus ensure a slow burning. 2 bar is approximately the pressure inside the gas bag, which is necessary for restraining. This is therefore deliberately far from the higher combustion pressures usual hitherto, which are present on burning of the propellant charge.

The propellant charge which is to be activated first is constructed such and accommodated in the gas generator such that it burns completely within a maximum of 30 ms and therefore provides the quantity of gas necessary for the primary impact.

The propellant charge or propellant charges which are to be activated subsequently have either their own igniters or ignite by auto-ignition and staggered over time due to they being heated, so that a so-called ignition transfer takes place.

The propellant charge or propellant charges which are subsequently to be activated are preferably insulated thermally with respect to other propellant charges, although they are arranged for example adjoining each other. Thereby, the staggering of time on igniting of the individual propellant charges is to be achieved or increased. A thermally insulating wall and a thermally insulating packing in which the propellant charge is accommodated are provided for this. The thermal insulation is to be constructed such that only at the end or, preferably, after the end of the burning of the fuel of the previously activated propellant charge does the auto-ignition of the following propellant charge take place.

The inflatable vehicle occupant restraint system proposed, which operates by the method proposed, provides a gas generator and a gas bag which is inflated by the gas generator. The fabric and the coating of the gas bag are coordinated with the gas generator with regard to their gas-permeability such that the gas bag has a service time of at least three seconds. The service time should be defined by the time the gas bag has at least approximately 2 bar internal pressure.

Preferably, however, a service time of six seconds is provided.

### BRIEF DESCRIPTION OF THE DRAWINGS

FIG. 1 shows a vehicle occupant restraint system operating in accordance with the method according to the invention, with a first embodiment of the gas generator according to the invention,

FIG. 2 shows a longitudinal sectional view through a second embodiment of the gas generator according to the invention,

FIG. 3 shows a longitudinal sectional view through a third embodiment of the gas generator according to the invention,

FIG. 4 shows a longitudinal sectional view through a fourth embodiment of the gas generator according to the invention and

FIG. 5 shows a longitudinal sectional view through a fifth embodiment of the gas generator according to the invention.

### DETAILED DESCRIPTION OF THE PREFERRED EMBODIMENTS

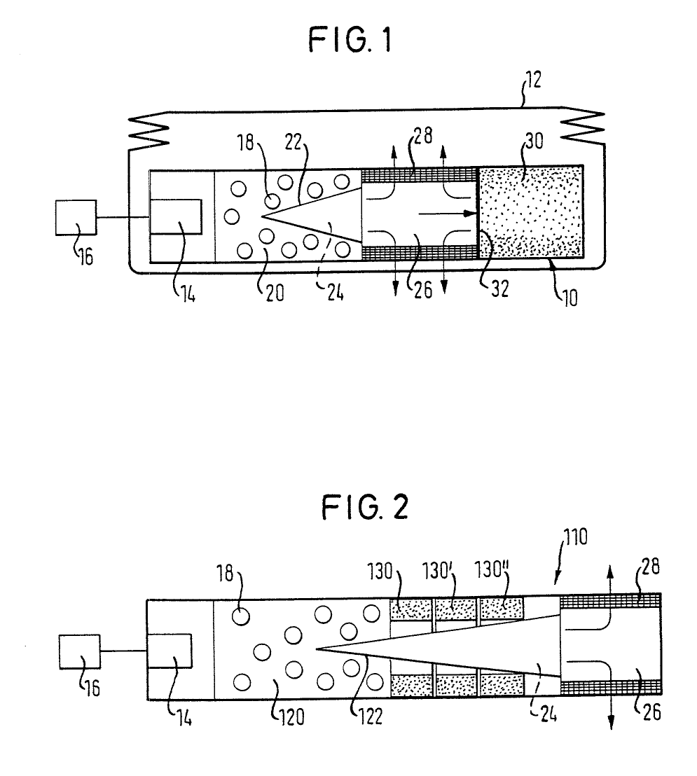

In FIG. 1 a vehicle occupant restraint system is illustrated, which has a gas generator 10 and a gas bag 12, connected with it with regard to flow and able to be inflated by it. The gas bag 12 is a so-called window bag, i.e. a side gas bag having a large area and covering the side windows of the vehicle in the case of restraint. In FIG. 1 it is shown that the gas generator 10 is arranged inside the gas bag 12, but it is also possible to connect gas generator 10 and gas bag 12 with each other with regard to flow via a gas-directing pipe.

The gas generator 10 is an elongated tubular gas generator, at one axial end of which an igniter 14 is arranged, which is connected with a control unit 16 which activates the igniter 14. A so-called primary propellant charge 18 which adjoins the igniter 14 and is to be ignited first in the case of restraint, consists of rapidly burning fuel in tablet form. The propellant charge 18 is accommodated in a combustion chamber 20. A conical filter cone 22 projecting into the interior of the combustion chamber 20 separates an expansion chamber 24 from the combustion chamber 20. Adjoining the expansion chamber 24 is a filter chamber 26 with cylindrical filters 28, in the outer region of which filter chamber the outer housing of the gas generator 10 has numerous outflow openings. Adjoining the axial end of the gas generator 10 opposed to the igniter 14 is a second propellant charge 30 which is to be ignited after the primary propellant charge 18, which second propellant charge 30 is likewise in flow connection with the filter chamber 26 but in the non-activated state is separated from the filter chamber 26 by a thermally insulating wall 32.

The gas bag 12 is coated on the inner face for example by means of a foil and is constructed such as to be almost (e.g. in parts) or completely gas-tight.

In the case of restraint, the gas generator inflates the gas bag according to the following method. The igniter 14 is activated and ignites the primary propellant charge 18. The fuel burns within a few milliseconds and the generated gas flows via the conical filter 22 with a large area very rapidly into the expansion chamber 24 and the filter chamber 26 and arrives through the filter 28 into the gas bag 12. The gas generator here provides a quantity of gas within a few milliseconds, which fully inflates the gas bag in approximately 20 ms. After the complete burning of the fuel of the propellant charge 18, the propellant charge 30 ignites itself. This takes place in that the housing and also the wall 32 heat up intensively with the outflow of the gas. With a specific chronological delay, this heat also arrives at the propellant charge 30, until the latter ignites itself. The propellant charge 30 has a fuel which burns substantially more slowly than that of the propellant charge 18. The propellant charge 30 preferably consists of the very slow-burning ammonium nitrate. The wall 32 is constructed with regard to its thermally insulating characteristics such that it directs to the propellant charge 30 in less than one second that amount of energy which is necessary for auto-ignition of the propellant charge 30. The latter then burns over more than one second, even preferably more than three seconds. The gas thus generated likewise arrives into the gas bag 12 via the filter chamber 26. The gas generator 10 consequently blows gas into the gas bag 12 over more than one second, preferably over more than three seconds, which gas bag 12 has a correspondingly long service time.

The gas-permeability of the gas bag and the gas generator are coordinated with each other such that the gas bag has a service time of more than three seconds, which means that it develops a protective effect over more than three seconds and in so doing preferably has more than 2 bar internal pressure.

The burning of the fuel of the propellant charge 30 takes place with a combustion pressure of a maximum of 2 bar, whereby the burning time can be very long.

In the embodiments according to FIGS. 2 to 5, for simplification the gas bag is no longer illustrated. For all the parts already explained hitherto, which also have a corresponding function in the following embodiments, the reference numbers already introduced are maintained. If the function or construction of the parts is different compared with the embodiment according to FIG. 1, then the corresponding parts are given a reference number increased by the number 100.

In the embodiment according to FIG. 2, the filter chamber 26 is arranged at the opposite end of the gas generator 110 to the igniter 14. The combustion chamber 120 not only contains the primary propellant charge 18 but also propellant charges 130, 130′ and 130″ which are subsequently to be ignited and which are constructed in a ring shape and extend around the conical filter 122. The individual propellant charges 130 to 130″ differ from each other in the geometry and/or the fuel composition.

After the igniting of the propellant charge 18, the gas flows via the tip of the filter 122 into the expansion chamber 24 and the filter chamber 26, from where it arrives into the gas bag and fully inflates the latter within a few milliseconds. During or at the end of the burning of the fuel of the propellant charge 18, through the generated hot gas the propellant charge 130, which is subsequently to be activated, is ignited. The corresponding gas likewise arrives via the filter 122 into the expansion chamber 24 and the filter chamber 26. The burning time of the fuel of the propellant charge 130 is, however, distinctly higher than that of the fuel of the propellant charge 18, so that over approximately one second gas is generated by the propellant charge 130. After the propellant charge 130 is burnt, the propellant charge 130′ arranged adjacent and then the propellant charge 130″ is activated, so that a gradual burning of the propellant charges takes place and the gas generator 110 conveys gas into the gas bag over more than three seconds. Through the provision of still more propellant charges, the inflation time and hence the service time of the gas bag is increased to more than five or six seconds, which is sufficient to also offer protection in a rollover of the vehicle.

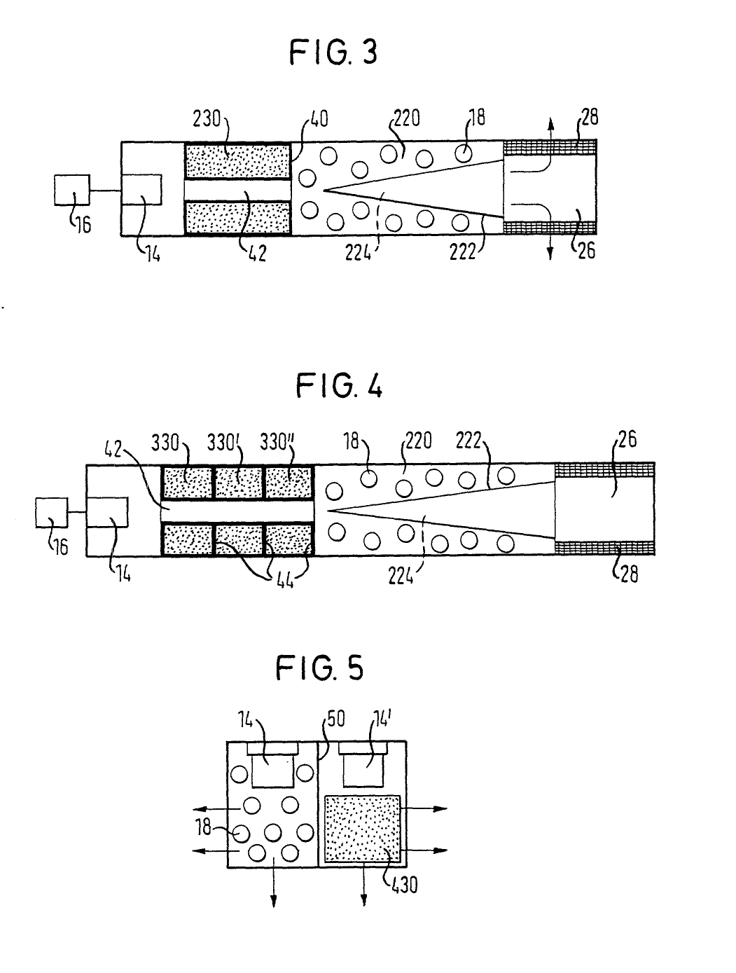

In the embodiment according to FIG. 3, a single propellant charge 230 to be subsequently ignited, is accommodated in a thermally insulating packing 40. The propellant charge 230 is cylindrical in construction and has an axially through-opening 42. The propellant charge 230 adjoins the igniter 14, but is arranged in the combustion chamber 220 as in the embodiment according to FIG. 2. The primary propellant charge 18 adjoins the propellant charge 230.

Through the opening 42, the igniter 14 ignites the fuel of the propellant charge 18. The generated gas arrives through the filter 222 into the expansion chamber 224 and from there into the filter chamber 26. The packing 40 is constructed such that on igniting of the propellant charge 18, no auto-ignition of the propellant charge 230 takes place. Only after the fuel of the propellant charge 18 is burnt does so much thermal energy arrive at the propellant charge 230 via the packing 40 that the propellant charge 230 ignites itself with a predeterminable time delay. Gas is generated over several seconds on burning of the fuel of the propellant charge 230, which keeps the gas bag inflated.

In the embodiment illustrated in FIG. 4, several propellant charges 330, 330′, 330″ are provided, spaced apart from each other by thermally insulating walls 44. Also in the region of the opening 42, the propellant charges 330 to 330″ are thermally insulated, so that they ignite themselves in succession, staggered chronologically, after the propellant charge 18 has been activated. In this embodiment, service times of six seconds and more are able to be achieved for the gas bag, and the gas generator generates gas over more than five seconds.

In the embodiment illustrated in FIG. 5, a primary propellant charge 18 and a propellant charge 430, which is to be ignited subsequently, are each equipped with one own igniter 14, 14′. The propellant charges 18, 430 are separated from each other via a wall 50. The propellant charge 18 serves for making the gas bag available quickly. Staggered chronologically to this, via the igniter 14 the propellant charge 430 is ignited, which consists of a very slow-burning fuel and provides for a long service time of the gas bag. In this embodiment, separate combustion chambers are provided for the individual propellant charges.

1. A method for inflating a gas bag for restraining an occupant, said method comprising the following steps:
providing a gas generator for producing gas which is flowingly connected to said gas bag,
providing at least one propellant charge within said gas generator,
providing at least one igniter within said gas generator,
said gas generator blowing gas into said gas bag over more than one second.

2. The method according to claim 1, wherein said gas generator and said gas bag are so adapted to each other that after activation of said gas generator said generator produces so much of said gas that within a maximum of 30 ms after activation of said gas generator said gas bag is fully inflated.

3. The method according to claim 1, wherein said gas is blown into said gas bag over more than three, preferably more than five seconds.

4. A gas generator for a vehicle occupant restraint system for inflating a gas bag said gas generator comprising
at least one propellant charge and
at least one igniter,
said propellant charge having such a nature and being accommodated in said gas generator such that it blows out said gas over more than one second.

5. The gas generator according to claim 4, wherein it is constructed such that it generates said gas over more than one second.

6. The gas generator according to claim 5, wherein it is constructed such that it generates said gas over more than three seconds.

7. The gas generator according to claim 6, wherein it is constructed such that it generates said gas over more than five seconds.

8. The gas generator according to claim 4, wherein a plurality of propellant charges is provided, which are able to be activated chronologically in succession.

9. The gas generator according to claim 4, wherein at least one of said propellant charges comprises ammonium nitrate.

10. The gas generator according to claim 9, wherein a primary propellant charge is provided which is to be activated first and wherein said propellant charge comprising ammonium nitrate is a propellant charge which is to be activated subsequently to said primary propellant charge.

11. The gas generator according to claim 10, wherein said gas generator is constructed such that said propellant charge which is to be activated subsequently burns at a maximum of 2 bar combustion pressure.

12. The gas generator according to claim 10, wherein it is constructed such that a fuel of said primary propellant charge which is to be activated first burns fully within 30 ms.

13. The gas generator according to claim 10, wherein said at least one propellant charge which is to be activated subsequently has its own igniter.

14. The gas generator according to claim 10, wherein said at least one propellant charge which is to be activated subsequently is constructed such that it ignites by auto-ignition and staggered over time with respect to said primary propellant charge.

15. The gas generator according to claim 14, wherein a combustion chamber is provided for said primary propellant charge, said at least one propellant charge which is to be activated subsequently being accommodated in said combustion chamber of said primary propellant charge.

16. The gas generator according to claim 15, wherein said at least one propellant charge which is to be activated subsequently is thermally insulated with respect to other propellant charges.

17. The gas generator according to claim 16, wherein several propellant charges are arranged so as to adjoin each other.

18. The gas generator according to claim 17, wherein a thermally insulating wall is provided, said propellant charges which adjoin each other being separated from each other by said thermally insulating wall.

19. The gas generator according to claim 17, wherein a thermally insulating packing is provided, said at least one propellant charge which is to be activated subsequently being accommodated in said thermally insulating packing.

20. The gas generator according to claim 18, wherein said thermally insulating wall is constructed such that an auto-ignition of said insulated propellant charge takes place only at or after the end of the burning of a fuel of a previously activated propellant charge.

21. The gas generator according to claim 19, wherein said thermally insulating packing is constructed such that an auto-ignition of said insulated propellant charge takes place only at or after the end of the burning of a fuel of a previously activated propellant charge.

22. An inflatable vehicle occupant restraint system, comprising
a gas generator including at least one propellant charge and at least one igniter, said propellant charge having such a nature and being accommodated in said gas generator such that it blows out said gas over more than one second, and
a gas bag which is inflated by said gas generator,
said gas bag having a coating which is impermeable to gas and said coating being coordinated with said gas generator such that said gas bag has a service time of at least three seconds, within which it has at least approximately 2 bar internal pressure.

23. The vehicle occupant restraint system according to claim 22, wherein said gas bag is constructed such and said gas generator and said gas bag are adapted to each other such that said gas bag has a service time of at least six seconds.
